(19) United States
(12) Patent Application Publication
(10) Pub. No.: US 2016/0104188 A1
(43) Pub. Date: Apr. 14, 2016

(54) CONSUMER PRICE PROTECTION SERVICE

(71) Applicant: Paribus Co., Brooklyn, NY (US)

(72) Inventors: Eric Robert Glyman, Brooklyn, NY (US); Karim Atiyeh, Brooklyn, NY (US); Mohammed Jassim AlMughrabi, Kuwait City (KW); Jennifer Ann Xia, Mukilteo, WA (US)

(73) Assignee: Paribus Co., Brooklyn, NY (US)

(21) Appl. No.: 14/878,137

(22) Filed: Oct. 8, 2015

Related U.S. Application Data
(60) Provisional application No. 62/061,660, filed on Oct. 8, 2014.

(51) Int. Cl. G06Q 30/02

(52) U.S. Cl. CPC G06Q 30/0234; G06Q 30/0239

(57) ABSTRACT

Prices, rebates and/or coupons may be monitored with respect to goods and/or services purchased by consumers. When applicable, store policies for price adjustments, rebates, and/or coupons may be saved, and websites may be searched for these price adjustments, rebates, and/or coupons. When a price adjustment, rebate, and/or coupon is found for a product or service purchased by a consumer, the system may automatically submit a claim for the price adjustment, rebate, and/or coupon. When the money is received by the consumer, the company offering the consumer monitoring service may charge the consumer a portion thereof.

### CROSS-REFERENCE TO RELATED APPLICATIONS

This application claims the benefit of U.S. Provisional Application Ser. No. 62/061,660 filed on Oct. 8, 2014. The subject matter of this earlier filed application is hereby incorporated by reference in its entirety.

### FIELD

The present invention generally relates to price protection, and more particularly, to a consumer price protection service that monitors consumer purchases and automatically applies for price adjustments, rebates, and/or coupons when applicable to the purchase.

### BACKGROUND

Many companies offer various price matching guarantees, rebates, and coupons. However, generally, the consumer must find better prices, rebates, and coupons themselves and submit them manually. This may be tedious, and furthermore, consumers are unlikely to be able to find all such deals themselves.

More recently, services such as Slice™ have been created that alert consumers that they may be eligible for a refund for purchased goods. However, consumers are still required to navigate through the proper channels of the entity offering the refund in order to obtain it. Accordingly, an improved approach to price protection may be beneficial.

### SUMMARY

Certain embodiments of the present invention may provide solutions to the problems and needs in the art that have not yet been fully identified, appreciated, or solved by current price protection technologies. For example, some embodiments pertain to a consumer price protection service that monitors consumer purchases. Store policies for price adjustments, rebates, and/or coupons may be saved, and websites may be searched for these price adjustments, rebates, and/or coupons. When a price adjustment, rebate, and/or coupon is found for a good or service purchased by a consumer, the system may automatically apply for the price adjustment, rebate, and/or coupon. When the money is received by the consumer, the company offering the consumer monitoring service may charge the consumer a portion of the money that was received.

In an embodiment, a computer-implemented method includes determining, by a computing system, that a user has purchased one or more products and/or services by monitoring an email account, an application, or both for information indicative that a purchase has been made and mapping, by the computing system, the one or more purchased products and/or services to one or more respective URLs on websites of retailers and/or service providers (RSPs). The computer-implemented method also includes determining, by the computing system, whether price matching, a rebate, a coupon, or any combination thereof, is available for the one or more purchased products and/or services and checking, by the computing system, whether a lower price is found when price matching exists, whether a rebate is found, whether a coupon is found, or any combination thereof that is beyond a predetermined threshold. In some embodiments, when a rebate and/or price matching is found, the computer-implemented method includes evaluating, by the computing system, the rebate, the price matching, or both against policies and/or restrictions or an RSP, a third party, or both. When beyond the predetermined threshold, the computer-implemented method also includes automatically generating and submitting a refund claim, by the computing system, for a difference in price, a rebate amount, a coupon amount, or any combination thereof. In certain embodiments, the computer-implemented method may further include monitoring, by the computing system, for whether the refund claim was successful. In some embodiments, when successful, the computer-implemented method additionally includes charging the user, an RSP, or both, a fee, by the computing system, that is less than a total amount of the refund claim.

In another embodiment, a computer program is embodied on a non-transitory computer-readable medium. The program configured to cause at least one processor to determine whether price matching, a rebate, a coupon, or any combination thereof, is available for a product or service offered by a RSP that is purchased by a user. The program is also configured to cause the at least one processor to check whether a lower price for the purchased product or service is found when price matching exists, whether a rebate is found, whether a coupon is found, or any combination thereof that is beyond a predetermined threshold. The computer program is further configured to cause the at least one processor to automatically generate and submit a refund claim for a difference in price, a rebate amount, a coupon amount, or any combination thereof when beyond the predetermined threshold.

In yet another embodiment, an apparatus includes memory storing computer program instructions and at least one processor configured to execute the computer program instructions. The at least one processor is configured to automatically generate and submit a refund claim for a product or service for a difference in price, a rebate amount, a coupon amount, or any combination thereof when beyond a predetermined threshold. The refund claim is generated using multiple synonyms, different body contents, different message lengths, spelling errors, or any combination thereof.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a consumer price protection system, according to an embodiment of the present invention.

FIG. 2 is a flowchart illustrating a process for identifying user purchases, according to an embodiment of the present invention.

FIG. 3 is a flowchart illustrating a process for tracking potential refunds, according to an embodiment of the present invention.

FIG. 4 is a flowchart illustrating a process for identifying a refund, according to an embodiment of the present invention.

FIG. 5 is a flowchart illustrating a process for filing a refund claim, according to an embodiment of the present invention.

FIG. 6 is a flowchart illustrating a process for verifying success and charging the user, according to an embodiment of the present invention.

FIG. 7 is a process diagram and graph illustrating a Paribus™ user collecting a refund based on the 2012 Samsung Galaxy S3™ price drop, according to an embodiment of the present invention.

FIG. 8A is a screenshot illustrating a price protection application dashboard that may be accessible to a user, according to an embodiment of the present invention.

FIG. 8B is a screenshot illustrating a price protection application purchases screen, according to an embodiment of the present invention.

FIG. 9 is a block diagram of a computing system configured to provide price protection functionality, according to an embodiment of the present invention.

### DETAILED DESCRIPTION OF THE EMBODIMENTS

Some embodiments of the present invention pertain to a software application, system, and process that monitors consumer purchases of goods and/or services. When applicable, store policies for price adjustments (i.e., based on price matching), rebates, and/or coupons may be saved, and websites may be searched for these price adjustments, rebates, and/or coupons. When a price adjustment, rebate, and/or coupon is found for a product or service purchased by a consumer, the system may automatically submit a claim for the price adjustment, rebate, and/or coupon. When the money is received by the consumer, the company offering the consumer monitoring service may charge the consumer a portion thereof. In essence, such a price protection service may obtain money from retailers and/or service providers and “split” the recovered funds with the consumer.

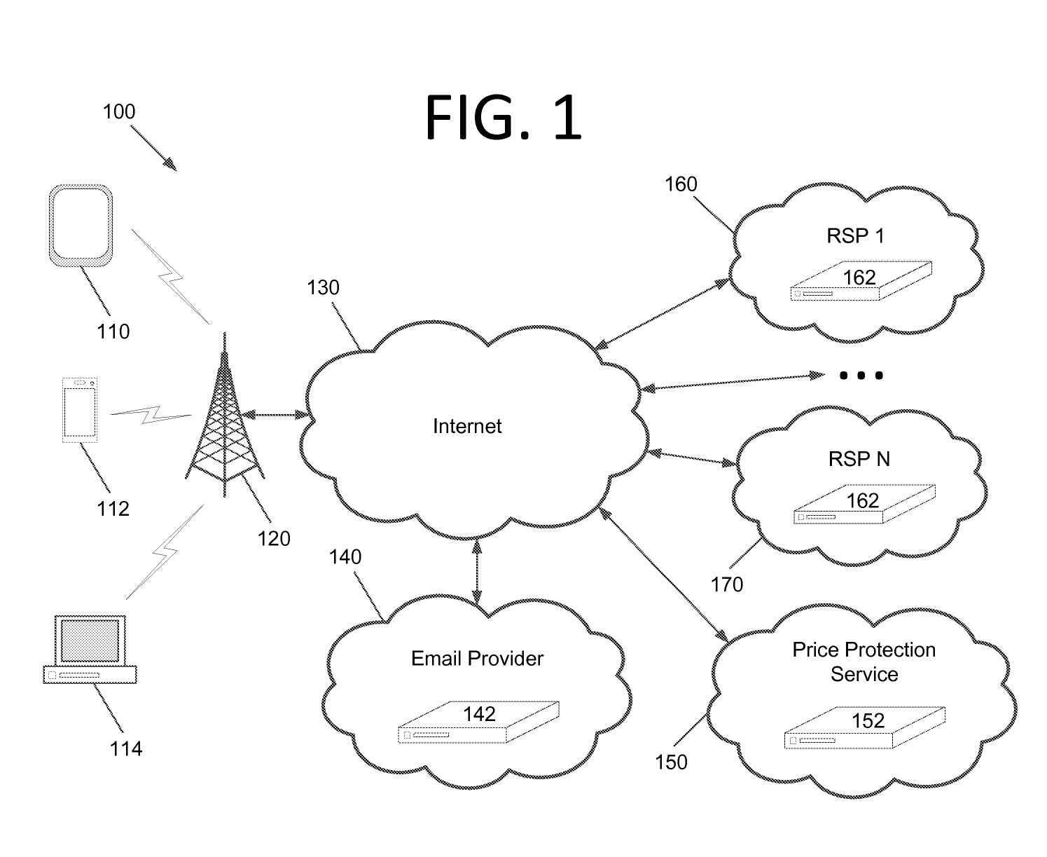

FIG. 1 is an architectural diagram illustrating a consumer price protection system 100, according to an embodiment of the present invention. A consumer makes online purchases from various retailers, service providers, or both using his or her computing systems. In this case, the user makes purchases using a tablet 110, a smart phone 112, and a desktop computer 114. However, any other suitable computing system may be used without deviating from the scope of the invention. Furthermore, while wireless communication via a cellular base station or wireless router 120 is shown here, any suitable wired communication (e.g., Ethernet) or wireless communication (e.g., satellite communication) by any suitable device may be used without deviating from the scope of the invention.

The consumer, utilizing a web browser, an application of a retailer and/or service provider (RSP), or a third party application, makes a purchase using a computing system 110,112,114 by communicating through base station or wireless router 120 and Internet 130 with the server(s) of any desired RSP, such as server 162 of RSP 1 160, a server of RSP 2 (not shown), . . . , server 172 of RSP N 170, etc. By way of non-limiting example, an RSP may be a retailer, a third party marketplace, a hotel, an airline, or any other entity that provides goods and/or services. One of ordinary skill in the art will also appreciate that while a single server is shown for each entity in FIG. 1 for the purposes of illustration, multiple servers, distributed computing systems, cloud computing systems, or any other suitable computing system or systems may be used without deviating from the scope of the invention.

Once a purchase is made, the corresponding RSP sends an email to the consumer confirming the purchase, which is received by email provider 140 via Internet 130 and stored on server 142. Price protection service 150 has access to the consumer's email account via server 152, and periodically checks the email account for new emails, receives push notifications from email provider 140 when new email arrives, or both. Additionally or alternatively, price protection service 150 may have access to an application that was used to make the purchase and use this application as a basis for determining when purchases were made.

In the case of email, price protection service 150 parses the email from the corresponding RSP and determines that a purchase was made. More specifically, price protection service 150 identifies the characteristics of the purchase and maps the purchase to the product page URL. Price protection service 150 then tracks the price of the good or service over time (at the original RSP and across other RSPs in some embodiments) and also finds applicable coupons. This may be performed by a combination of internal algorithms and external APIs that find the webpages that are relevant for a particular good or service (e.g., URLs at different RSPs) than then the prices may be pulled in real time or near-real time in some embodiments and stored in a database (e.g., stored in memory of server 152).

Based on this tracking, price protection service 150 determines whether lower prices are found via price matching, whether a rebate may exist, and/or whether one or more coupons may exist for the purchased item that will be honored by the associated RSP. As used herein, price matching may be for matching the prices of other RSPs, matching prices of the same RSP when the price drops, or both. When a price matching policy exists and a lower price is found, when a rebate is found, and/or when one or more coupons are found, price protection service 150 checks whether the price matching, rebate, and/or coupon(s) are valid for the given purchase. If valid, price protection service submits the appropriate claim to the RSP for the price matching, rebate, and/or coupon(s).

Price protection service 150 monitors the consumer's email, the application, or both to determine when money is received from the RSP. When the money is received, price protection service 150 records that the money has been received and charges the user a fee for the service (e.g., 25% of the amount that was received). Price protection service 150 then charges a credit card, sends the user a bill, debits from a bank account, or receives payment in any other suitable way or combination of ways. Price protection service 150 may also wait until a certain period of time has elapsed and bill the consumer for successful transactions at that time (e.g., on a monthly basis).

In order to determine what price matching policies, rebates, and/or coupons may be available, price protection service 150 may monitor websites of RSPs 1 through N for these items. RSP policies may be entered manually or determined automatically. Price, coupon, and rebate information may be scraped from RSP websites, third party websites, applications, emails, or any other suitable data source.

Identifying User Purchases

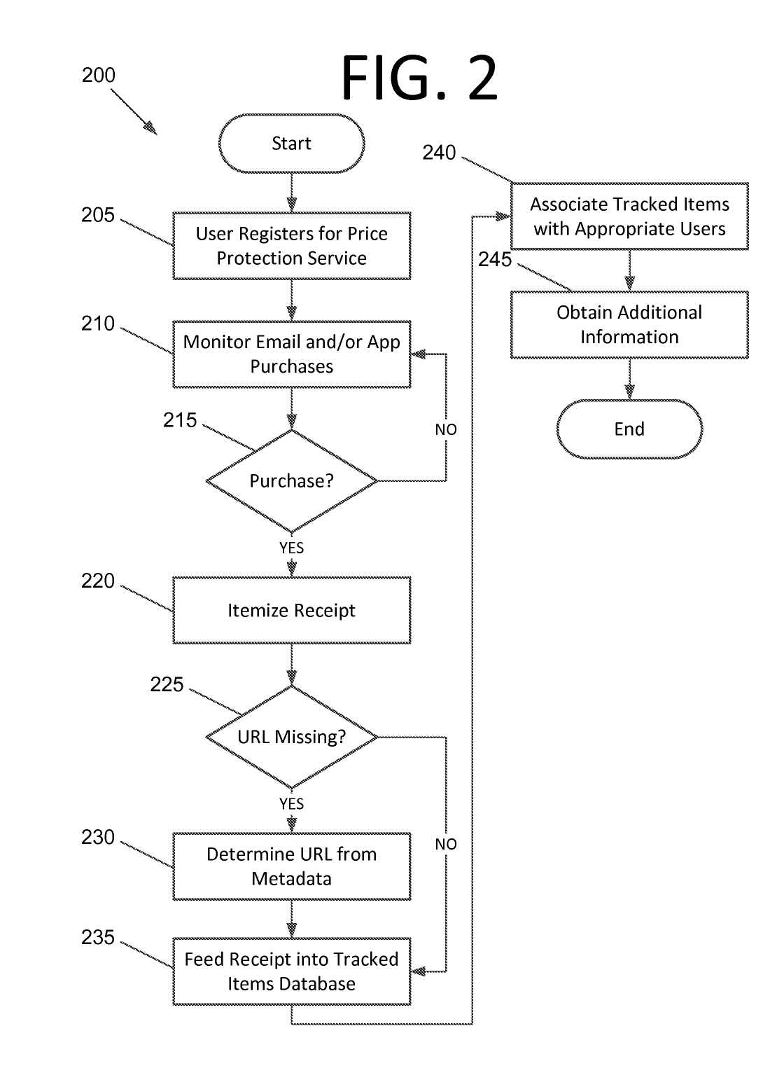

In many embodiments, user purchases of goods and/or services are monitored to determine what to monitor for that consumer. This may be accomplished by monitoring the consumer's email account, monitoring one or more RSP and/or third party applications, or both. FIG. 2 is a flowchart 200 illustrating a process for identifying user purchases, according to an embodiment of the present invention. The process begins with a consumer registering a price protection service at 205. When registering (or subsequently to registering in some embodiments), the user provides access to one or more email accounts, RSP credentials, and/or credentials to an online account that has purchase information (e.g., an Amazon™ username and password). When email is used to determine user purchases, the user may provide his or her email account information (e.g., email address, password, etc.) to the price protection service. The price protection service may then “sit between” user purchases using a proxy server that is in the user's proximity and begins accumulating credentials with the RSP, or the RSP may separately access the application. More specifically, the price protection service may safeguard user credentials and act as an agent on the user's behalf to monitor purchases from different web accounts. For instance, the user may submit credentials, the price protection service may verify the credentials by attempting to log in on his or her behalf, and the price protection service may encrypt the credentials and use them to pull purchase information on behalf of the user. When doing this, user behavior may be replicated (e.g., utilizing the same browser, cookies, identifying information, a similar IP address, etc.). Alternatively, the price protection service could be integrated directly into the application (e.g., Amazon™, Overstock™ Jet™, etc.). The user could also directly submit receipts to the price protection service.

The price protection service provider then monitors email and/or application traffic for purchases. For instance, in the case of email, the price protection service may monitor mailbox traffic for new orders/receipts. This may be accomplished by monitoring email metadata and/or the body of the email for the email address, the words “order” or “receipt,” the format of the subject, dollar signs or other currency signs in the email body, etc. For instance, ship-confirm@amazon.com may be sufficient to indicate that an item has been ordered from Amazon™. However, any suitable information to determine an order may be used without deviating from the scope of the invention.

However, it should be noted that not all stores provide itemized receipts. In this case, the transaction may still be detected, but there may not be enough information to successfully map the purchase to a product. In this case, the user may provide his or her account with the RSP (e.g., an Amazon™ account) to bridge this gap. In this case, the price protection service may “sit in the middle” between the RSP and the user when the user establishes his or her account. The price protection service can then use the login information to access the account with the RSP.

When an order is determined at 215, the receipt is then itemized at 220 by parsing, scanning, and classifying the receipt using Xpath and regular expressions, for example, to extract data about the items that were purchased (e.g., item identifier (ID), price, size, color, product uniform resource locator (URL), etc.). Artificial intelligence logic may be used to parse the receipt, classify it, and add new companies in some embodiments. Often, the product URL is missing from the receipt. If this is the case at 225, available metadata may be used to map the product to the appropriate URL for the item on the RSP's website at 230. The URL for the good or service can often be constructed directly from the metadata available in the email. For example, a J.Crew™ product URL may look like this:

https://www.jcrew.com/mens_category/bags/Harwick/PRD˜E1726/E1726.jsp!nav_type=OBIN

In this URL the category (mens/bags) and brand and product identifier (E1726) found in the email may be used to reconstruct the product URL. The category can also be asserted from the user data (e.g., male) and/or the image of the item (bag).

Image information and properties may also be used in some embodiments. For instance, if the receipt includes the item description “polo shirt,” but the color is not known, a code in the image may indicate that the color is white, or image may be analyzed to determine the item color by looking at the RGB values and checking whether they are in a range that indicates white (perhaps 250, 250, 250 and higher would be deemed white). The receipt is then fed into a tracked items database at 235.

Tracked items are associated with the appropriate users at 240. In other words, a user ID may be linked to a purchase and the information about the user may be used to help determine product details (e.g., this person is a store member so he/she always gets a discount, this person is a female so she is more likely to buy female items, etc.). Additional information on tracked items is obtained at 245 by crawling through RSP websites and third party databases and/or APIs. A non-limiting example of such a database is Semantics3™ (Semantics3.com).

Tracking Potential Refunds

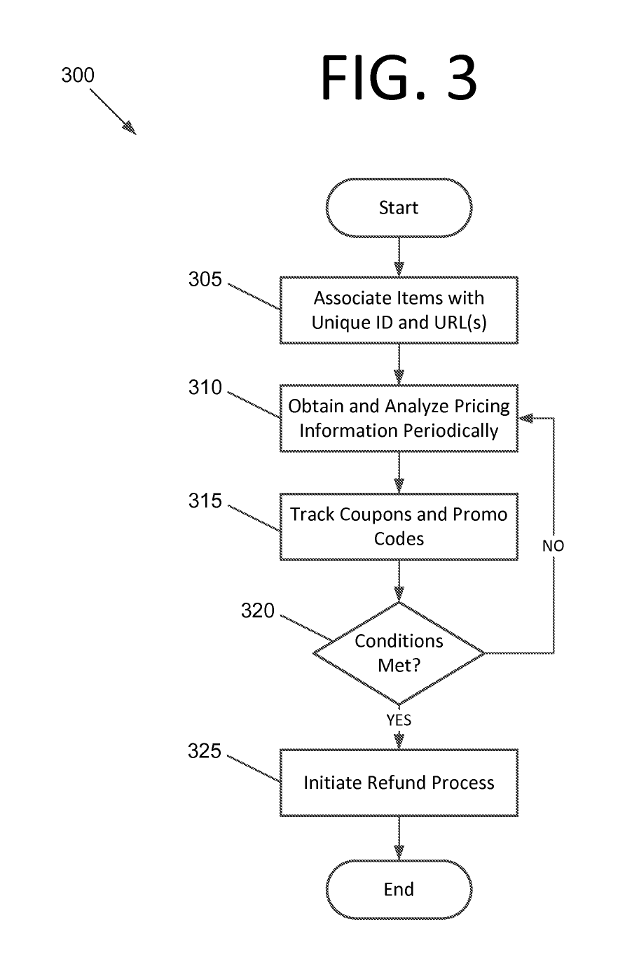

Pricing information on various websites can be used to determine pricing and coupons. In the case of price matching, various RSP prices may be tracked and stored. FIG. 3 is a flowchart 300 illustrating a process for tracking potential refunds, according to an embodiment of the present invention. Each item or service in the database may be associated with a unique ID (e.g., Amazon™ ID, ISBN, etc.) and one or more URLs at 305. Because URLs may change for a product or service, products or services may be removed from certain RSPs, and new RSPs may be added, URLs may be added, modified, and removed as desired. The information may be obtained and analyzed at 310 and used to track prices across multiple RSPs.

For instance, pricing information from websites may be scraped and analyzed. From the URL, the structure of the page may be determined and the price may be pulled. If the item is recently purchased by a consumer, the price may be checked more often. However, if a purchase is older, the price may be checked less often. This may be accomplished by an algorithm that starts with a predetermined checking frequency and then reduces the frequency with which checking is performed over time, perhaps eventually to no checking, checking once per week, etc. User purchases may be used to establish items, items may be pre-populated, or a combination thereof.

In some embodiments, it may be determined how often the price changes for a given item in response to determined user purchases, periodic checking, or both. The frequency with which the price is checked (or “scraped”) may be set or adjusted based on the price change frequency. For instance, scraping may be turned off for items that are coming through relatively frequently (e.g., averaging once per minute, hourly, daily, etc.). It may also be determined whether different users, or a certain class of users (e.g., users in a certain geographic location, users who purchased at a certain time of day, etc.) receive different pricing. If several users are charged different price for the same item within a certain time period (e.g., on the same day), this may be used in order to file claims. For instance, some embodiments not only get pricing information and coupons by crawling/scraping, but also by using the information gathered on what users are being charged and which coupons they are applying. For example, if a user finds and applies a 20% off coupon that he or she found, the price protection service may use this information (e.g., extracted from an RSP email or receipt) to apply the same coupon for other eligible users.

As such, it may be possible to “reverse-engineer” the algorithm used by the RSP for pricing. Because, different users may be charged different prices, scraping may be performed anonymously in an attempt to prevent a price increase. Scraping may be kept anonymous by using a third-party proxy service that provides the flexibility to specify cookies, browser headers, IP addresses, etc. This allows the price protections service to decide to appear as a user on a specific operating system (e.g., Windows™ vs. OS X™) and a specific browser (e.g., Mobile Safari™ vs Desktop IE™, etc.), for example.

For some RSPs, the application programming interfaces (APIs) for these RSPs may be reverse-engineered and used to get the price. Reverse engineering an API on a website may be performed by accessing the website while monitoring network calls. Some of the outbound network calls may have the form of an HTTP GET request, where the variables submitted include a product identifier, for example, and the response includes the price of the item. Monitoring network calls may be done using an appropriate HTTP monitor, like http://www.charlesproxy.com/ in some embodiments. This may be less computationally intensive than scanning a web page, thus making the data collection more efficient.

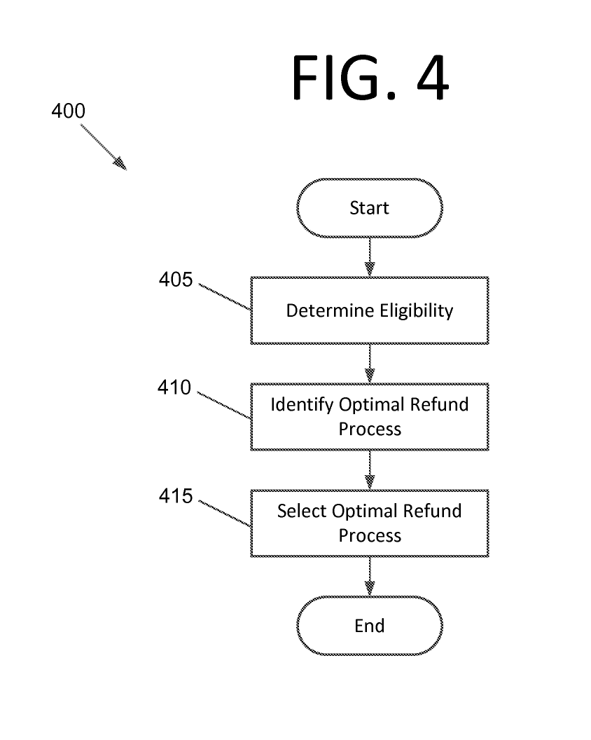

Coupons and promo codes can also be pulled and tracked at 315, and a price history can be built based, in part, on this information. If certain conditions that are tracked in the database are met at 320, e.g., a 10% price drop during the protection period or a missed coupon or promotion code, the refund process may be triggered at 325. In some embodiments, this may include the processes of FIGS. 4-6. In this embodiment, the process ends after the refund process. However, in many embodiments, URLs may still be added, modified, removed, and periodically checked after the first refund request is initiated.

Identifying an Optimal Refund

Once the refund process is triggered, an optimal refund for the consumer may be identified. FIG. 4 is a flowchart 400 illustrating a process for identifying a refund, according to an embodiment of the present invention. The process begins with checking whether the item or service is eligible for a price drop claim, a coupon claim, or a price match claim at 405. For instance, in the case of price adjustments, RSP policies and/or policies of third parties (e.g., credit card companies, manufacturers, etc.) may be saved in the database and terms of service, exceptions, time limits, etc. may be analyzed. For instance, third party items from Amazon™ are not eligible for price matching. However, policies of credit card companies, manufacturers, and the like may apply, such as a manufacturer rebate. Also, certain exceptions, such as excluding electronics, clothing, etc., may apply. The policy information may be entered manually into the database or automatically parsed from a RSP website, a receipt, or any other suitable source. In the case of automatic embodiments, the system may be trained via word association or via any other suitable approach.

Given the transaction profile (e.g., credit card that was used, RSP type, product type, etc.) and user preferences (e.g., fast vs. cheap), an optimal refund process may be identified at 410. The optimal refund process may be determined, for example, by evaluation of criteria such as the type of product, date of purchase and/or current date, place, time of day, form of payment, etc., across multiple policies and/or counterparties. In other words, what is known about the user may be used to determine what type of refund should be filed. If it is known that the user uses a credit card that has price protection (e.g., a Chase Sapphire™ card) and it is also known that the price protection policy of the credit card is faster to process and more reliable to that of the RSP, the price protection service may determine that the claim should be filed through the credit card provider instead of the RSP. This may also be the point where the price protection service determines whether to file a price drop claim or a price match claim. For instance, if a user buys a shirt from Nordstrom™, which has a price match and price protection guarantee, for $180, and it turns out that the shirt is sold for $150 by a competitor, the algorithm may wait a few days before filing a price match claim because it may be determined that there is a high likelihood that Nordstrom™ will drop its price further within the price adjustment eligibility period. Both the date of purchase and the current date may be used to determine how long the price protection service should wait for a better deal before filing a refund. The pricing model for historical/future expected price changes may also be considered in the evaluation. Historical information based on claims filed and information on RSP policies may be used. The optimal refund process is then selected at 415.

Filing a Refund Claim

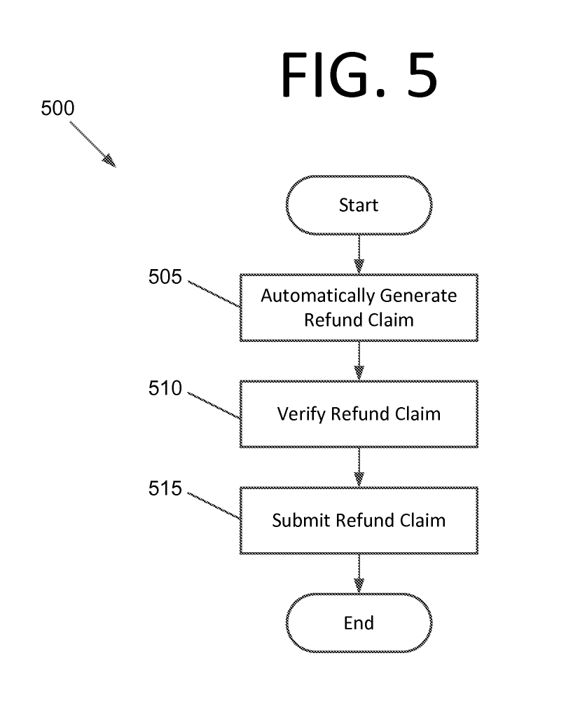

Once the optimal refund process is selected, a claim can be generated and filed. FIG. 5 is a flowchart 500 illustrating a process for filing a refund claim, according to an embodiment of the present invention. The process begins with automatically generating a refund claim for the user at 505. Claims may be generated using web forms, web chat, email, etc., depending on the policy of the RSP for how refund requests are to be submitted. Templates may be used for each of these claim types in some embodiments, and perhaps for each RSP. Also, templates may “talk to each other” and multiple templates may be submitted. For instance, there may be sub-templates within templates. A template may be constructed as an extension of another template. For example, there may be a parent template for “price matching” and child templates for “price matching against Walmart™” and “price matching against Amazon™”

By way of non-limiting example, a claim may say “Hello. I bought <ITEM NAME> at <PURCHASE PRICE> on <DATE>, but I see now that the price is <LOWER PRICE> on your website. Please send me a refund in the amount of <DIFFERENCE>. Thanks!” Templates may use multiple synonyms that are selected using a pseudo-random algorithm, e.g., hi, hello, greetings, etc. for the greeting. Different body contents may also be swapped in and out from request to request, also on a pseudo-random basis, and message length may be varied. Furthermore, spelling mistakes may be introduced to create the appearance that the request came from a human. In some embodiments, the user's email may be analyzed for grammar and syntax patterns, the frequency and nature of spelling errors, etc. If the price protection has the user's authorization, it may monitor the user's communication with RSPs and analyze the writing style and error rate, for example. This gives the price protection service the ability to replicate a similar writing style when writing claims on the user's behalf. For instance, the price protection service may introduce a few spelling mistakes, use long and/or run-on sentences, etc. This information may then be used to generate a request that appears to have come from that specific user. Stochastic/Markov model processes may be applied to determine and perform these variations as well.

A screenshot or screenshots proving the price drop, a proof of purchase, etc., may also be submitted with the claim. This information may also be requested from the user first if needed. The refund request may be verified for accuracy prior to sending via an automated system or a human agent at 510. The refund request is then submitted through the web form, web chat, email, etc. at 515.

An advantage of some embodiments is that the RSP does not know that the request was automatically generated. The claim may actually be sent from the user's account. RSPs may apply statistical models in an attempt to block automatically generated claims, but claims generated with these variations will be hard to detect due to the lack of a readily discernible pattern.

Verifying Success and Charging the User

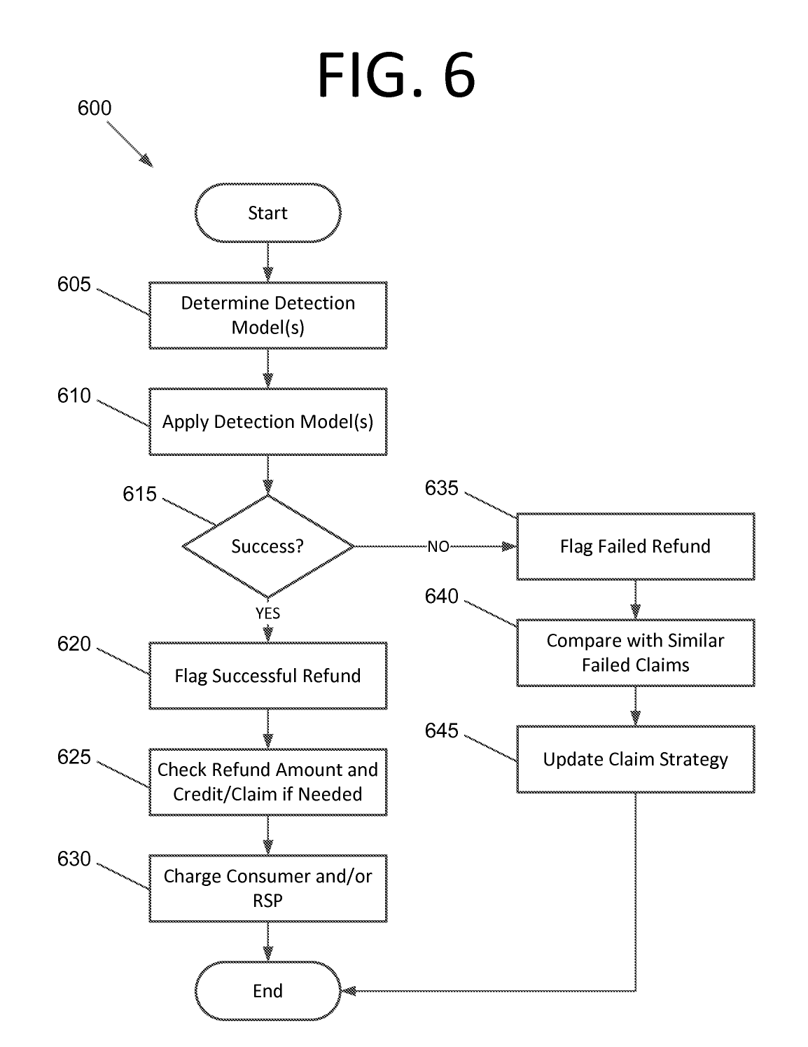

Once a refund claim is submitted, many embodiments monitor to see whether the claim was successful. FIG. 6 is a flowchart 600 illustrating a process for verifying success and charging the user, according to an embodiment of the present invention. The process begins with determining a success/failure detection model to apply at 605. In some embodiments, one or more of several models is used to identify a successful claim including, but not limited to: (1) search for certain email address(es); (2) direct parsing of structured response communications; and/or (3) a scoring methodology optimized via machine learning to efficiently detect success from sentence structure/word occurrences. The selected model(s) is/are then applied at 610.

If the refund is successful based on the applied model(s) at 615, the refund claim is flagged as successful at 620 and the claim is checked against the amount that should have been provided at 625. If the refund is less than the amount that should have been provided, the claim process may be repeated seeking the difference. If the claim was more than what was owed, a payment may be issued to the RSP for the amount of the overpayment. The user is then charged a portion of the correct refund at 630 (e.g., 5%, 10%, 25%, etc.). In some embodiments, the price protection service may partner with the RSP and store credit may be provided in lieu of payment. In such embodiments, the price protection service may seek payment from the RSP entirely, or seek some payment from the RSP and some payment from the user.

However, if the refund claim is not successful at 615, the failed refund is flagged at 635, the failed claim is compared with other, similar failed claims at 640, and the claim strategy is updated for future similar claims at 645. This may be a machine learning process that hones the effectiveness of claims, and/or failed messages could be kicked to a human for analysis. For instance, if the price protection service determines that it is getting a high percentage of claims rejected and the RSP responses all contains the words “color” and “size”, this provides a hint that the initial claim that was submitted may be missing information about the color and size of the item. In other words, the content of the RSP responses may be analyzed automatically and/or manually to improve the completeness and effectiveness of the claims that are submitted.

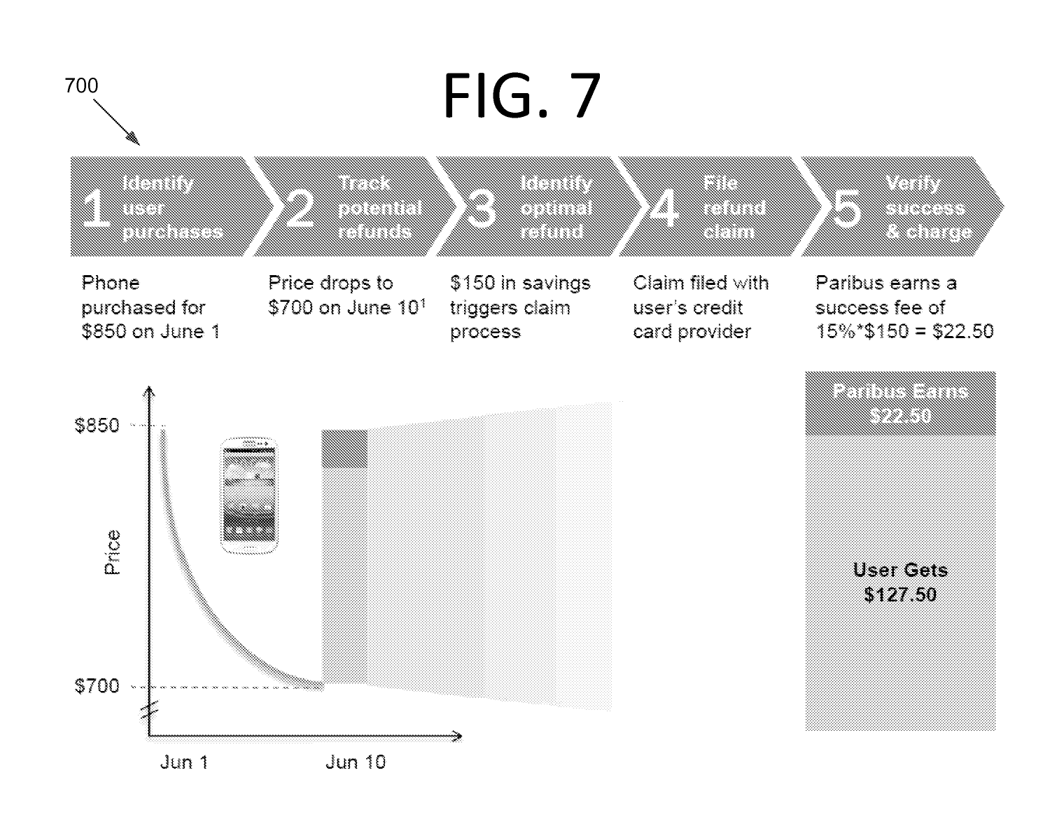

FIG. 7 is a process diagram and graph 700 illustrating a Paribus™ user collecting a refund based on the 2012 Samsung Galaxy S3™ price drop, according to an embodiment of the present invention. This is by way of example only and does not relate to an actual user of the product, which was not released at that time. In this example, the user purchased the phone for $850 on Jun. 1, 2012. On Jun. 10, 2012, however, the price dropped to $700. The $150 difference triggers a claim process, and a claim is filed with the user's credit card provider based on a policy. After verification of success, the user earns $127.50 and Paribus earns $22.50 (15%).

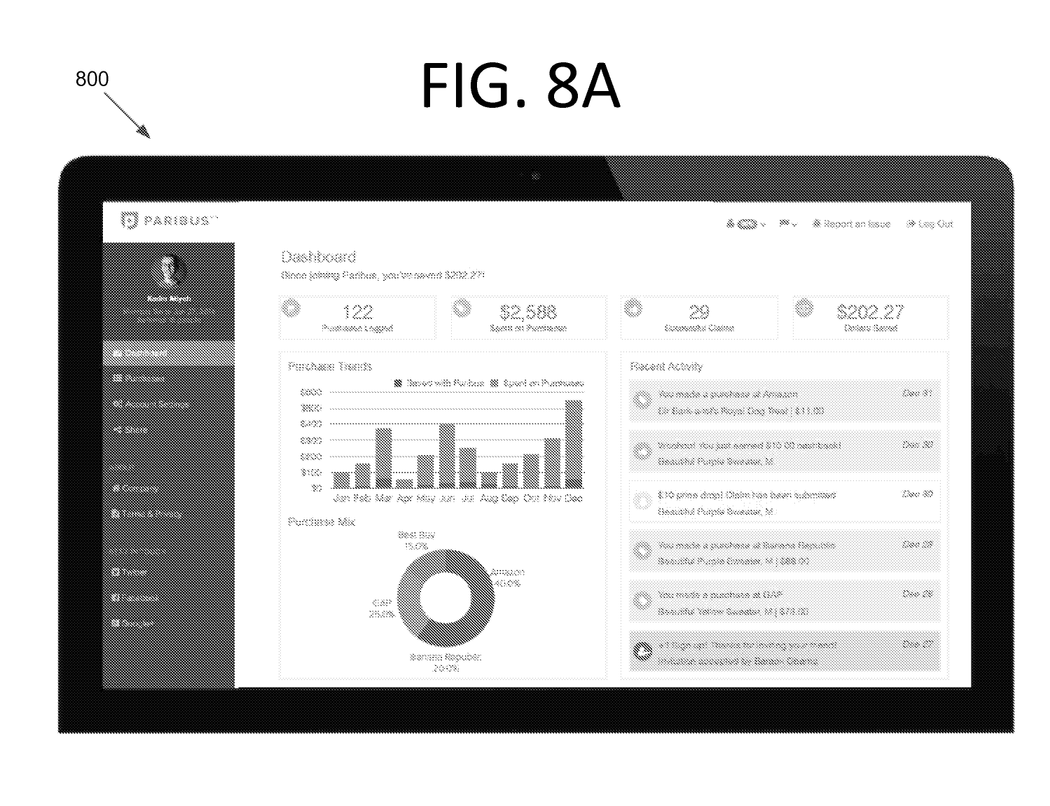

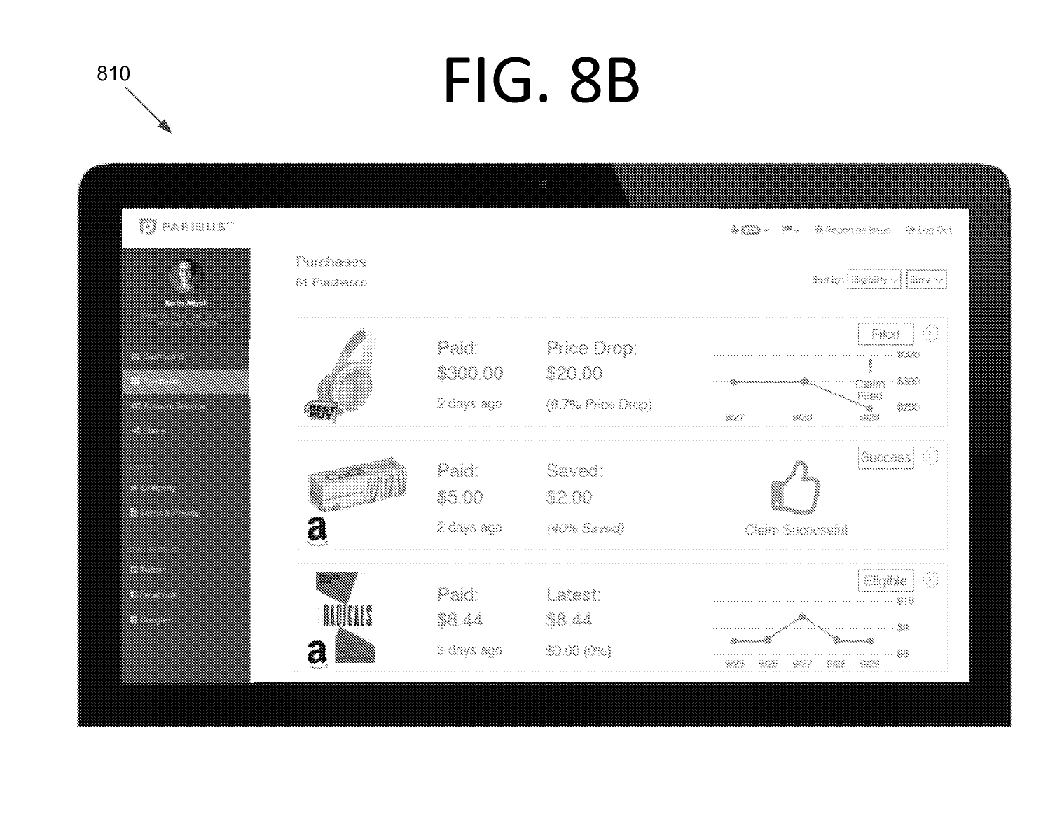

FIG. 8A is a screenshot illustrating a price protection application dashboard 800 that may be accessible to a user, according to an embodiment of the present invention. Dashboard 800 provides the user with a centralized place to view purchases, the current price, eligibility status (e.g., eligible for a claim, not eligible for a claim, claim filed, etc.), and other information. In this embodiment, the user can see recent purchases from multiple online stores in one organized, and searchable, dashboard. Statistics on recent purchases, claims, savings, and trends are provided. Also, statistics on recent purchases, claims, savings over time, and trends are presented. The user can further see analytics on past purchase behavior and an activity feed of a claims engine (e.g., when purchases were made, claims that were filed, claims marked as successful, etc.).

FIG. 8B is a screenshot illustrating a price protection application purchases screen 810, according to an embodiment of the present invention. Purchases screen 810 provides price change charts on recent purchases. For instance, in this case, the user can see that the price of a pair of headphones dropped 6.7% between the date of purchase on 9/27 and the filing of a claim on 9/29.

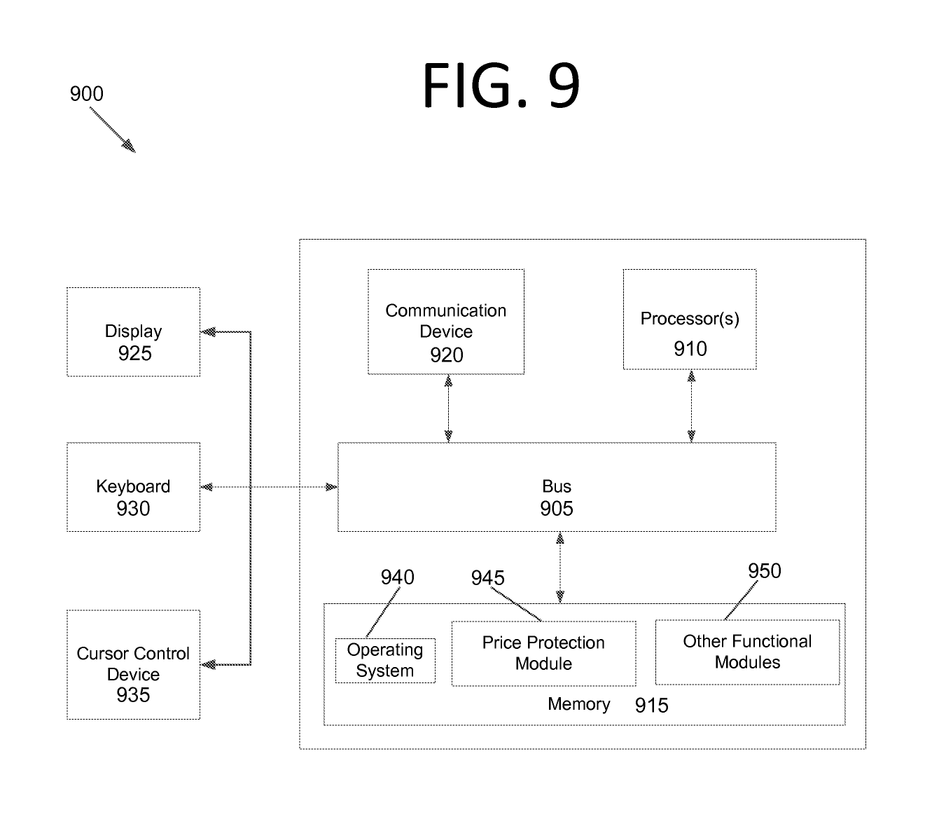

FIG. 9 is a block diagram of a computing system 900 configured to provide price protection functionality, according to an embodiment of the present invention. Computing system 900 includes a bus 905 or other communication mechanism for communicating information, and processor(s) 910 coupled to bus 905 for processing information. Processor(s) 910 may be any type of general or specific purpose processor, including a central processing unit (“CPU”) or application specific integrated circuit (“ASIC”). Processor(s) 910 may also have multiple processing cores, and at least some of the cores may be configured to perform specific functions. Computing system 900 further includes a memory 915 for storing information and instructions to be executed by processor(s) 910. Memory 915 can be comprised of any combination of random access memory (“RAM”), read only memory (“ROM”), flash memory, cache, static storage such as a magnetic or optical disk, or any other types of non-transitory computer-readable media or combinations thereof. Additionally, computing system 900 includes a communication device 920, such as a transceiver, to wirelessly provide access to a communications network.

Non-transitory computer-readable media may be any available media that can be accessed by processor(s) 910 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 910 are further coupled via bus 905 to a display 925, such as a Liquid Crystal Display (“LCD”), for displaying information to a user. A keyboard 930 and a cursor control device 935, such as a computer mouse, are further coupled to bus 905 to enable a user to interface with computing system 900. However, in certain embodiments such as those for mobile computing implementations, a physical keyboard and mouse may not be present, and the user may interact with the device solely through display 925 and/or a touchpad (not shown). Any type and combination of input devices may be used as a matter of design choice.

In one embodiment, memory 915 stores software modules that provide functionality when executed by processor(s) 910. The modules include an operating system 940 for computing system 900. The modules further include a price protection module 945 that is configured to perform the various operations disclosed herein pertaining to price protection. Computing system 900 may include one or more additional functional modules 950 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method steps performed in FIGS. 2-6 may be performed by a computer program, encoding instructions for the nonlinear adaptive processor to perform at least the methods described in 2-6, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in 2-6, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
determining, by a computing system, that a user has purchased one or more products and/or services by monitoring an email account, an application, or both for information indicative that a purchase has been made;
mapping, by the computing system, the one or more purchased products and/or services to one or more respective URLs on websites of retailers and/or service providers (RSPs);
determining, by the computing system, whether price matching, a rebate, a coupon, or any combination thereof, is available for the one or more purchased products and/or services;
checking, by the computing system, whether a lower price is found when price matching exists, whether a rebate is found, whether a coupon is found, or any combination thereof that is beyond a predetermined threshold; and
when beyond the predetermined threshold, automatically generating and submitting a refund claim, by the computing system, for a difference in price, a rebate amount, a coupon amount, or any combination thereof.

2. The computer-implemented method of claim 1, wherein when a rebate and/or price matching is found, the computer-implemented method further comprises:
evaluating, by the computing system, the rebate, the price matching, or both against policies and/or restrictions of an RSP, a third party, or both.

3. The computer-implemented method of claim 1, wherein the mapping further comprises:
identifying, by the computing system, characteristics of the purchased products and/or services from the email account, the application, or both, wherein
the identified characteristics of the purchased products and/or services comprise a color, a category, a sex, a name, and/or a description.

4. The computer-implemented method of claim 1, further comprising:
tracking, by the computing system, prices of the purchased products and/or services over time across a plurality of RSPs and finding applicable coupons.

5. The computer-implemented method of claim 4, further comprising:
associating the tracked products and/or services, by the computing system, with the user by linking a user ID to a purchase; and
using information about the user, by the computing system, to determine details pertaining to the products and/or services.

6. The computer-implemented method of claim 1, further comprising:
obtaining access, by the computing system, to one or more email accounts, RSP credentials, and/or credentials to an online account that has purchase information.

7. The computer-implemented method of claim 1, further comprising:
accumulating credentials, by the computing system, with one or more RSPs from which the user has purchased the products and/or services.

8. The computer-implemented method of claim 7, wherein the accumulating of the credentials comprises:
safeguarding user credentials, by the computing system, and acting as an agent on the user's behalf to monitor purchases from different web accounts by attempting to log in on the user's behalf, encrypting the credentials, and using the credentials to pull purchase information on behalf of the user.

9. The computer-implemented method of claim 8, further comprising:
replicating user behavior, by the computing system, by utilizing a same web browser, cookies, identifying information, and using a similar IP address.

10. The computer-implemented method of claim 1, wherein the mapping further comprises:
using available metadata, by the computing system, to reconstruct the URLs.

11. The computer-implemented method of claim 1, wherein the mapping further comprises:
analyzing image information and properties, by the computing system, to determine information regarding a respective product or service.

12. The computer-implemented method of claim 1, further comprising:
removing a URL for an existing product or service for an RSP, by the computing system, when it is determined that the URL for the product or service is no longer valid;
adding a URL for a new product or service for the RSP, by the computing system, to an RSP when it is determined that the new product or service is offered by the RSP; and
modifying a URL for an existing product or service for an RSP, by the computing system, when it is determined that the URL for the product or service has changed.

13. The computer-implemented method of claim 1, further comprising:
checking for price changes, rebates, and/or coupons for a product or service, by the computing system, with a frequency that is based on how often the product or service is purchased by users, such that products and/or services that are purchased more frequently are checked more often, and products and/or services that are purchased less frequently are checked less often.

14. The computer-implemented method of claim 1, further comprising:
checking for price changes, rebates, and/or coupons for a product or service, by the computing system, with a frequency that is based on how often one or more RSPs change a price of the product or service.

15. The computer-implemented method of claim 1, further comprising:
scraping, by the computing system, pricing information for a product or service from one or more RSPs from one or more RSP websites, third party websites, applications, and/or emails.

16. The computer-implemented method of claim 15, further comprising:
turning off the scraping, by the computing system, when the product or service is being purchased by users with at least a predetermined frequency.

17. The computer-implemented method of claim 15, wherein the scraping is performed anonymously to prevent a price increase.

18. The computer-implemented method of claim 1, further comprising:
determining, by the computing system, whether different users and/or a certain class of users receive different pricing; and
when different pricing is determined, using this information, by the computing system, to file one or more claims.

19. The computer-implemented method of claim 18, further comprising:
reverse-engineering a pricing algorithm used by an RSP, by the computing system, based on the determined different pricing.

20. The computer-implemented method of claim 1, further comprising:
reverse-engineering application programming interfaces (APIs), by the computing system, for one or more RSPs; and
using the reverse-engineered APIs, by the computing system, to get prices.

21. The computer-implemented method of claim 1, further comprising:
determining an optimal refund process, by the computing system, by examining a transaction profile and user preferences.

22. The computer-implemented method of claim 1, further comprising:
examining, by the computing system, historical information based on claims that have been filed and RSP policies; and
using the historical information, by the computing system, to determine an optimal refund process.

23. The computer-implemented method of claim 1, wherein the refund claim is automatically generated using a web form, web chat, and/or an email.

24. The computer-implemented method of claim 1, further comprising:
generating templates, by the computing system, for different claim types, different RSPs, or both.

25. The computer-implemented method of claim 24, further comprising
generating one or more sub-templates for a template, by the computing system, as extensions of the template.

26. The computer-implemented method of claim 1, wherein the refund claim is generated using multiple synonyms, different body contents, different message lengths, spelling errors, or any combination thereof.

27. The computer-implemented method of claim 26, further comprising:
analyzing user email, by the computing system, for grammar and syntax patterns, a frequency and nature of spelling errors, or both; and
based on the analysis, replicating the user's writing style, by the computing system, when generating the refund claim.

28. The computer-implemented method of claim 1, further comprising:
submitting, by the computing system, one or more screenshots with the refund claim.

29. The computer-implemented method of claim 28, further comprising:
requesting the one or more screenshots from the user, by the computing system, prior to generating the refund claim.

30. The computer-implemented method of claim 1, further comprising:
monitoring, by the computing system, for whether the refund claim was successful.

31. The computer-implemented method of claim 30, wherein when the refund claim is successful, the method further comprises:
checking, by the computing system, the refund claim against an amount that should have been provided;
when the refund is less than the amount that should have been provided, submitting a new refund claim, by the computing system, seeking the difference; and
when the refund is more than the amount that should have been provided, issuing a payment to the RSP, by the computing system, for the difference.

32. The computer-implemented method of claim 30, wherein when the refund claim is not successful, the method further comprises:
comparing the failed refund claim, by the computing system, with one or more other failed claims; and
updating a claim strategy, by the computing system, based on the comparison.

33. The computer-implemented method of claim 30, further comprising:
when the refund claim was successful, charging the user, an RSP, or both, a fee, by the computing system, that is less than a total amount of the refund claim.

34. A computer program embodied on a non-transitory computer-readable medium, the program configured to cause at least one processor to:
determine whether price matching, a rebate, a coupon, or any combination thereof, is available for a product or service offered by a retailer and/or service provider (RSP) that is purchased by a user;
check whether a lower price for the purchased product or service is found when price matching exists, whether a rebate is found, whether a coupon is found, or any combination thereof that is beyond a predetermined threshold; and
when beyond the predetermined threshold, automatically generating and submitting a refund claim for a difference in price, a rebate amount, a coupon amount, or any combination thereof.

35. The computer program of claim 34, wherein the program is further configured to cause the at least one processor to:
determine that the user has purchased the product or service by monitoring an email account, an application, or both for information indicative that a purchase has been made; and
map the purchased product or service to one or more respective URLs on websites of RSPs.

36. The computer program of claim 34, the program configured to cause the at least one processor to:
evaluate the rebate, the price matching, or both against policies and/or restrictions of an RSP, a third party, or both.

37. The computer program of claim 34, the program configured to cause the at least one processor to:
track prices of the purchased product or service over time across a plurality of RSPs.

38. The computer program of claim 34, the program configured to cause the at least one processor to:
scrape pricing information for the product or service from one or more RSPs from one or more RSP websites, third party websites, applications, and/or emails.

39. The computer program of claim 34, the program configured to cause the at least one processor to:
generate templates for different claim types, different RSPs, or both.

40. The computer program of claim 39, wherein the refund claim is generated using multiple synonyms, different body contents, different message lengths, spelling errors, or any combination thereof.

41. An apparatus, comprising:
memory storing computer program instructions; and
at least one processor configured to execute the computer program instructions, the at least one processor configured to:
automatically generate and submit a refund claim for a product or service for a difference in price, a rebate amount, a coupon amount, or any combination thereof when beyond a predetermined threshold, wherein
the refund claim is generated using multiple synonyms, different body contents, different message lengths, spelling errors, or any combination thereof.

42. The apparatus of claim 41, wherein the at least one processor is also configured to:
analyze user email for grammar and syntax patterns, a frequency and nature of spelling errors, or both; and
based on the analysis, replicate the user's writing style when generating the refund claim.
